(19) United States
(12) Patent Application Publication
(10) Pub. No.: US 2019/0266346 A1
(43) Pub. Date: Aug. 29, 2019

(54) SYSTEM AND METHOD FOR PRIVACY PROTECTION OF SENSITIVE INFORMATION FROM AUTONOMOUS VEHICLE SENSORS

(71) Applicant: Walmart Apollo, LLC, Bentonville, AR (US)

(72) Inventors: John J. O'Brien, Farmington, AR (US); Robert Cantrell, Herndon, VA (US); David Winkle, Bella Vista, AR (US); Donald R. High, Noel, MO (US)

(73) Assignee: Walmart Apollo, LLC, Bentonville, AR (US)

(21) Appl. No.: 16/288,340

(22) Filed: Feb. 28, 2019

Related U.S. Application Data
(60) Provisional application No. 62/636,747, filed on Feb. 28, 2018.

(51) Int. Cl. G06F 21/62; G06K 9/00; H04N 7/18; H04N 5/77; G06F 21/60; G05D 1/10

(52) U.S. Cl. CPC G06F 21/6245; G06K 9/00228; G06K 9/00718; G05D 1/101; H04N 5/77; G06F 21/602; H04N 7/183

(57) ABSTRACT

Systems, methods, and computer-readable storage media for providing increased security to sensitive data acquired by autonomous vehicles. This is done using a flexible classification and storage system, where information about the autonomous vehicle's mission is used in conjunction with sensor data to determine if the sensor data is necessary to the mission. When the sensor data, the location of the autonomous vehicle, and other data indicate that the autonomous vehicle has captured non-mission specific data, it can be deleted, encrypted, fragmented, or otherwise partitioned, with the goal of protecting that sensitive information.

### CROSS-REFERENCE TO RELATED APPLICATION

This application claims the benefit of U.S. Provisional Patent Application No. 62/636,747, filed Feb. 28, 2018, which is incorporated herein by reference in its entirety.

### BACKGROUND

### 1. Technical Field

The present disclosure relates to protecting sensitive data acquired by autonomous vehicles, and more specifically to modifying how data is processed and/or stored based on items identified by the autonomous vehicle.

### 2. Introduction

Autonomous vehicles rely on optical and auditory sensors to successfully navigate. For example, many of the driverless vehicles being designed for transporting human beings are using a combination of optics, LiDAR (Light Detection and Ranging), radar, and acoustic sensors to determine location with respect to roads, obstacles, and other vehicles. As the various sensors receive light, sound, and other information, and transform that information into usable data, some of the data may be sensitive and/or private. For example, an autonomous vehicle may record, in the process of navigation, the face of a human walking on a street. In another example, a drone flying over private property may, in the course of navigation, obtain footage of humans in a swimming pool. In such cases, privacy and discretion regarding information about the humans captured in the sensor information should be of paramount importance.

### SUMMARY

A system configured according to this disclosure can be configured to perform an exemplary method which includes: receiving, at an autonomous vehicle, a mission profile, the mission profile comprising: location coordinates for a route, the route extending from a starting location to a second location; and an action to perform at the second location; receiving, from an optical sensor of the autonomous vehicle as the autonomous vehicle is travelling the route, a video feed of surroundings of the autonomous vehicle; as the video feed is received, performing a shape recognition analysis on the video feed via a processor configured to perform shape recognition analysis, to yield a processed video feed; receiving location coordinates of the autonomous vehicle; determining, based on the location coordinates, that the autonomous vehicle is not engaged in the action to be performed at the second location, to yield a determination; identifying within the processed video feed, via the processor and based on the determination, an unencrypted first portion of the processed video feed as containing a face of a human being, and an unencrypted second portion of the processed video feed as not containing any face of human beings; encrypting the unencrypted first portion of the processed video feed, to yield an encrypted first portion of the processed video feed; and recording the encrypted first portion of the processed video feed and the unencrypted second portion of the processed video feed onto a computer-readable storage device.

An exemplary autonomous vehicle configured according to this disclosure can include: an optical sensor; a processor; and a computer-readable storage medium having instructions stored which, when executed by the processor, cause the processor to perform operation comprising: receiving a mission profile, the mission profile comprising: location coordinates for a route, the route extending from a starting location to a second location; and an action to perform at the second location; receiving, as the autonomous vehicle is travelling the route, a video feed of surroundings of the autonomous vehicle; as the video feed is received, performing a shape recognition analysis on the video feed, to yield a processed video feed; receiving location coordinates of the autonomous vehicle; determining, based on the location coordinates, that the autonomous vehicle is not engaged in the action to be performed at the second location, to yield a determination; identifying within the processed video feed, based on the determination, an unencrypted first portion of the processed video feed as containing a face of a human being, and an unencrypted second portion of the processed video feed as not containing any face of human beings; encrypting the unencrypted first portion of the processed video feed, to yield an encrypted first portion of the processed video feed; and recording the encrypted first portion of the processed video feed and the unencrypted second portion of the processed video feed onto the computer-readable storage medium.

An exemplary non-transitory computer-readable storage medium can have instructions stored which, when executed by a computing device, can perform operations which include: receiving a mission profile to be accomplished by an autonomous vehicle, the mission profile comprising: location coordinates for a route, the route extending from a starting location to a second location; and an action to perform at the second location; receiving, as the autonomous vehicle is travelling the route, a video feed of surroundings of the autonomous vehicle; as the video feed is received, performing a shape recognition analysis on the video feed, to yield a processed video feed; receiving location coordinates of the autonomous vehicle; determining, based on the location coordinates, that the autonomous vehicle is not engaged in the action to be performed at the second location, to yield a determination; identifying within the processed video feed, based on the determination, an unencrypted first portion of the processed video feed as containing a face of a human being, and an unencrypted second portion of the processed video feed as not containing any face of human beings; encrypting the unencrypted first portion of the processed video feed, to yield an encrypted first portion of the processed video feed; and recording the encrypted first portion of the processed video feed and the unencrypted second portion of the processed video feed onto the computer-readable storage device.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of a drone flying over a house while in transit;

FIG. 2 illustrates an example of a video feed having encrypted and non-encrypted portions;

FIG. 3 illustrates variable power requirements for different portions of a mission;

FIG. 4 illustrates a first flowchart example of a security analysis;

FIG. 5 illustrates a second flowchart example of the security analysis;

FIG. 6 illustrates a third flow chart example of the security analysis;

FIG. 7 illustrates an example of the security analysis;

FIG. 8 illustrates an exemplary method embodiment; and

FIG. 9 illustrates an exemplary computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Drones, driverless vehicles, and other autonomous vehicles obtain sensor data which can be used for navigation, and for verification of actions being performed as required by a mission. This data can be tiered by level of significance, such that images which are significant to the mission, and images which are not significant to the mission, can be processed in a distinct manner. For example, captured information such as humanoid features, license plates, etc. may be detected and be determined to be irrelevant to the current mission, and be blurred, deleted without saving, encrypted, or moved to a secured vault, whereas data relevant to the current mission may be retained in an unaltered state. Likewise, levels of encryption can be used based on the level of significance or sensitivity of the captured information.

By altering the way the various data is processed, the overall security/privacy associated with captured data can increase. Specifically, when security processes are required (based on the location, or data collected by various sensor), the system can engage those security processes for specific portions of the data. The remaining portions of the data can remain unmodified. In this manner, the security of the data is increased in a flexible manner. The variable security implementation also improves the computing power necessary, as a reduced computational load is required for the unmodified data compared to the modified data with the extra security.

Consider the following example. A drone is being used to deliver goods from a warehouse to a customer's house. As the drone is flying from the warehouse to the customer's house, the drone flies over the house of a non-customer, and captures imagery of a non-customer in that space. The drone can perform image recognition analysis on the video feed during the flight, and recognizes that footage of the non-customer was captured. The drone can then perform encryption on just that portion of the footage, essentially creating two portions of the video footage: an encrypted portion and a non-encrypted portion. After encrypting that portion of the video footage, the drone can stop encrypting and return to normal processing of the video footage. If additional portions are identified with images or data which needs to be given extra security, the drone can encrypt those additional portions. By changing how data is processed based on the contents of the data, the drone saves power while providing increased security to the video footage (or other sensor data) captured.

In another example, an automated vehicle (such as a driverless car) has been granted permission to use a combination of audio and optical sensor data in navigating around a city. As the automated vehicle approaches a street corner, a conversation is captured between two human beings. The automated vehicle may receive the speech/sound waves, then convert the speech to text. The automated vehicle may, based on the location of the automated vehicle and the current mission of the automated vehicle, determine if the speech is likely to be part of the mission. The automated vehicle can also analyze the subject matter of the speech. If the subject matter of the speech is outside of a contextual range of the automated vehicle's mission, the automated vehicle can encrypt, delete, modify, or otherwise ignore that portion of the audio.

As another example, customer permissions may be obtained to make recordings. As a drone approaches a customer's house where a package is to be delivered, the drone can switch from a status of ignoring surroundings determined not to be mission relevant to a status of recording all surroundings. In another example, the drone can switch from a low resolution camera to a higher resolution camera, in order to capture details about the drop off of the package.

In some cases, an autonomous vehicle can use no-fly zones, such as government installations, police buildings, military bases, home no-fly-zones, etc., as a geo-fence where resolution of captured data and/or subsequent processing of captured data is limited or restricted. For example, as a drone approaches a no-fly zone, the drone may be required to reduce the resolution of an optical sensor, delete any captured video, cease recording audio, etc. Likewise, as an autonomous vehicle approaches other scenarios, such as a known-dangerous turn, a congested air space, a delivery location, a fueling location, etc., the autonomous vehicle may be required to initiate a higher resolution on optics, sound, and/or navigation processing. This higher resolution may be required to assist in future programming, or to assess culpability if there are accidents or accusations in the future. Likewise, if there were an accident, high resolution video and/or audio may assist in determining who was at fault, or why the error occurred.

In some configurations, the sensor data acquired can be partitioned into portions which are more secure and portions which are less secure. For example, some portions may be encrypted when they contain sensitive information such as humanoid faces, identities, voices, etc., whereas portions which do not contain that information may not be encrypted. In addition, in some configurations the sensor data can be further partitioned such that portions requiring additional security are stored in a separate location than the portions which do not require additional security. For example, after encrypting some portions, the encrypted portions can be segmented and stored in a secure “vault,” meaning a portion of a database which has additional security requirements for access compared to that for the normal portions of the sensor information.

Resolution of optical sensors (cameras), audio, etc., can vary based on the data being received as well as the current automated vehicle location. For example, as a drone is in transit, the resolution of the optical sensors may be too low to recognize anything other than basic shapes and landmarks, whereas when the drone begins to approach the location where a delivery is going to be made, or a package acquired, the drone switches to a high resolution.

Similarly, the resolution of LiDAR, radar, audio, or other sensors may be modified, or even turned off, in certain situations. For example, as a drone is in transit between a start location and a second location where a specific action will occur, the audio sensor may be completely disabled. As the drone begins an approach to the second location (meaning the drone is within a pre-determined distance to the second location and is beginning a descent, or otherwise changing course to arrive at the second location), the audio sensor may first be set to a lower level, allowing for detection of some sounds, and then set to a higher level upon arriving at the second location. Upon leaving, the audio can again be disabled.

Respective tiers of resolution, encoding, encryption, etc., can be applied to any applicable type of sensor or sensor data. In addition, the levels can be set based on circumstances (i.e., the location of the autonomous vehicle with respect to restricted areas, detection of restricted content), permissions granted, or can be based on mission specific requirements. For example, in a mission which is within a threshold amount of the autonomous vehicle's capacity, the mission directives may cause the resolutions of various sensors to be incapacitated more than in other missions, with the goal of preserving energy to accomplish the mission.

The disclosure now turns to the specific examples illustrated in the figures. While specific examples are provided, aspects of the configurations provided may be added to, mixed, modified, or removed based on the specific requirements of any given configuration.

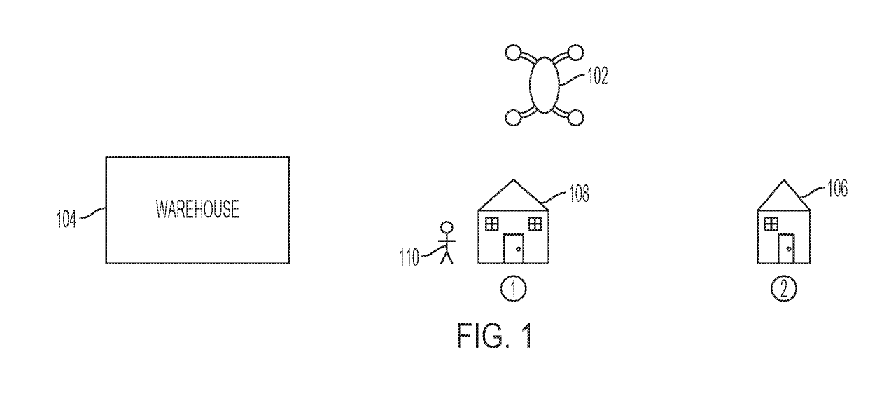

FIG. 1 illustrates an example of a drone 102 flying over a house 108 while in transit from a warehouse 104 to a customer's house 106. As the drone 102 is flying, the drone detects an individual 110. In some configurations, the face of the individual 110 can then be blurred within the video feed/data captured by the drone. In other configurations, the portion of the video feed can be encrypted, such that accessing the data captured by the drone 102 is restricted to those who can properly decrypt the data. For example, the encrypted portions of the video could only be accessed by drone management requiring multiple keys (physical or digital) to be simultaneously presented. Alternatively, the encrypted portions of the video may require police presence or a judicial warrant to be opened.

The data stored in the drone 102, including the encrypted/non-encrypted portions, may be stored on the drone 102 until the drone 102 makes the delivery at the customer's house 106, then returns to the distribution center 104 or a maintenance center. Upon returning, the data can be securely transferred to a database and removed from the drone 102.

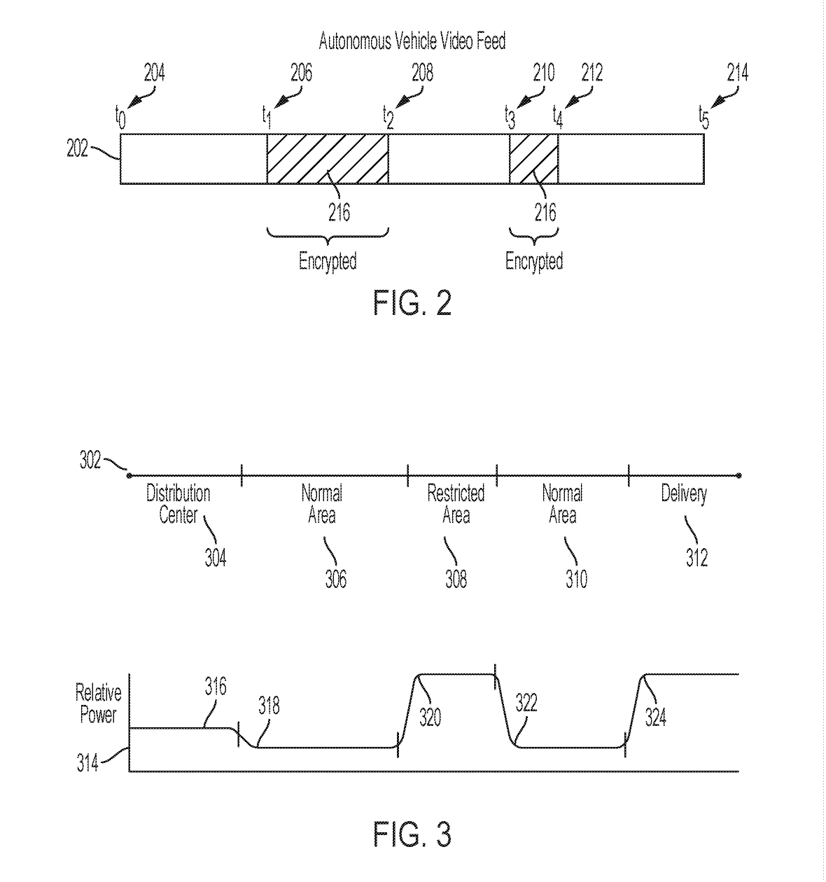

FIG. 2 illustrates an example of a video feed 202 having encrypted 216 and non-encrypted portions. As the autonomous vehicle performs missions and encounters various non-mission specific information, or sensitive information, the autonomous vehicle can secure the data. In this example, the autonomous vehicle begins recording video at time to 204. The data in this example is unencrypted until time t₁ 206, at which point the autonomous vehicle begins encrypting the video feed. Exemplary triggers for beginning the encryption can be entry into a restricted zone, a received communication, and detection of private information (such as a human's face, a non-mission essential conversation, license plate information, etc.). After a pre-set period of time, expiration of trigger (by leaving the area, or the information no longer being captured), the encryption can end. In this example, the encryption ends at time t₂ 208, and continues unencrypted until time t₃ 210, when encryption is again triggered for a brief period of time. At time t₄ 212 the encryption ends, and the video feed terminates at time t₅ 214 in an unencrypted state.

In this example, the portions of the video 216 which require additional security are encrypted. However, in other examples, the secured portions 216 may be segmented and stored in alternative locations. If necessary, as part of the segmentation additional frames can be generated. For example, if the video feed is using an Predicted (P) or Bi-directional (B) frames/slices for the video compression (frames which rely on neighboring frames to acquire sufficient data to be displayed), the segmentation algorithm can generate an Intracoded (I) frame containing all the data necessary to display the respective frame, and remove the P or B frames which were going to be the point of segmentation.

FIG. 3 illustrates variable power requirements of a drone processor for different portions of a mission. In this example, the top portion 302 of FIG. 3 illustrates the general area through which a drone moves in making a delivery. The drone begins at a distribution center 304, passes through a normal (non-restricted) area 306, a restricted area 308, another normal area 310, and arrives at a delivery location. The bottom portion 314 of FIG. 3 illustrates exemplary power requirements of the on-board drone processor in securing and processing the data acquired by the drone sensors as the drone passes through the corresponding areas.

For example, as the drone is in the distribution center 304, the drone is receiving information such as drone maintenance information, mission information, etc., and the power being consumed by the processor is at a first level 316. As the drone leaves the distribution center 304 and enters a normal area 306, the drone processor power consumption can drop 318, because the processor only needs to use minimal processes to help maintain the drone on course. While the overall power consumption of the drone may be high during this transit period 306, the power consumption of the processor may be relatively lower than while in the distribution center 304. As the drone enters a restricted area 308, the processor can begin encrypting (or otherwise securing) the sensitive information acquired by the drone sensors. Because the securing processes require additional computing power, the power consumption of the processor increases 320 while the drone is in the restricted area 308. Upon leaving the restricted area 308 for another normal area 310, the power consumption of the processor 322 again drops. When the drone makes the delivery 312, the power consumption of the processor 324 can again rise based on the requirement to record and secure information associated with the delivery.

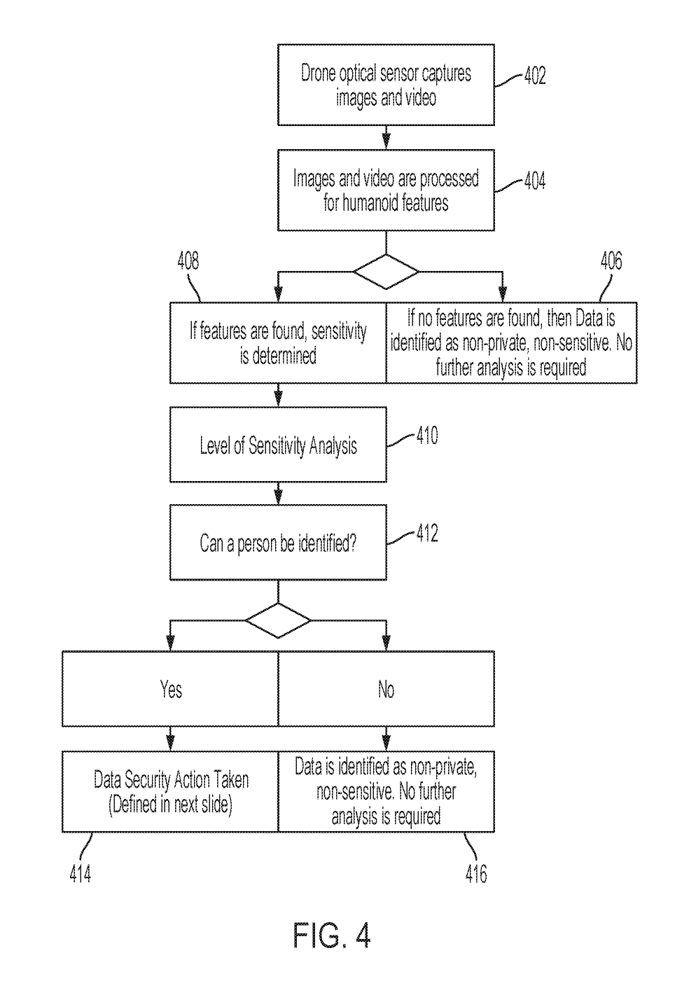

FIGS. 4-7 illustrate an exemplary security analysis. The steps outlined herein are exemplary and can be implemented in any combination thereof, including combinations that exclude, add, or modify certain steps.

FIG. 4 illustrates a first flowchart example of a security analysis. In this example, the drone optical sensor captures images and video 402, then processes those images and video to detect humanoid features 404. If no features are found, then the data can be classified as non-private, non-sensitive data, and no further analysis is required 406. However, if humanoid features are found 408, a sensitivity of the features will need to be determined.

The level of sensitivity analysis 410 can rely on comparison of the features detected to known cultural or legal bounds. For example, a detected license plate may be classified as having a first/low level of sensitivity, whereas nudity or other legal classification may be classified as highly sensitive. In this example, the system then determines if a person can be identified 412. If not, the data can be identified as non-private and non-sensitive 416. In other examples, identification of a person may only be one portion of the determination to classify/secure data. If a person can be identified 414, this exemplary configuration requires that a security action be taken.

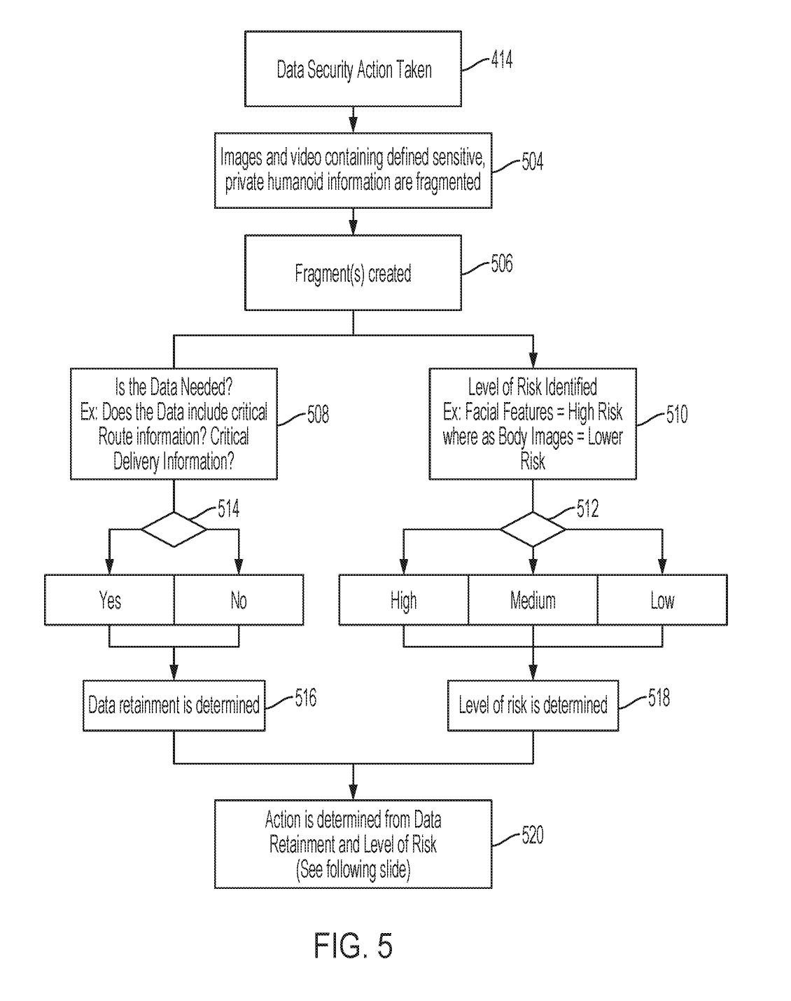

FIG. 5 continues from FIG. 4, and illustrates a second flowchart example of the security analysis. In this portion of the example, the data security action is taken 414, meaning that the images and video containing defined sensitive, private humanoid information are fragmented 504. The fragment(s) are then created 506, and for each fragment, the system determines (1) is the data needed? 508, and (2) what is the level of risk identified? 512. To make the determination of “is the data needed” 508, the system analyzes if the information acquired contains mission critical data, meaning information critical to the autonomous vehicle completing its route and or being able to perform the action (such as a delivery) required.

Regarding the level of risk identified, the system can rank the security required for the data acquired. For example, images and video of a clothed body may be considered (in this example) to be a lower risk, and therefore require lower security, whereas images and video of a person's face may have a higher risk, and therefore require a higher level of security. The system makes each respective determination 514, 512, generating a determination to retain the data (or not) 516 as well as a level of risk 518. An action is then determined based on the data retention 516 determination and the level of risk 518.

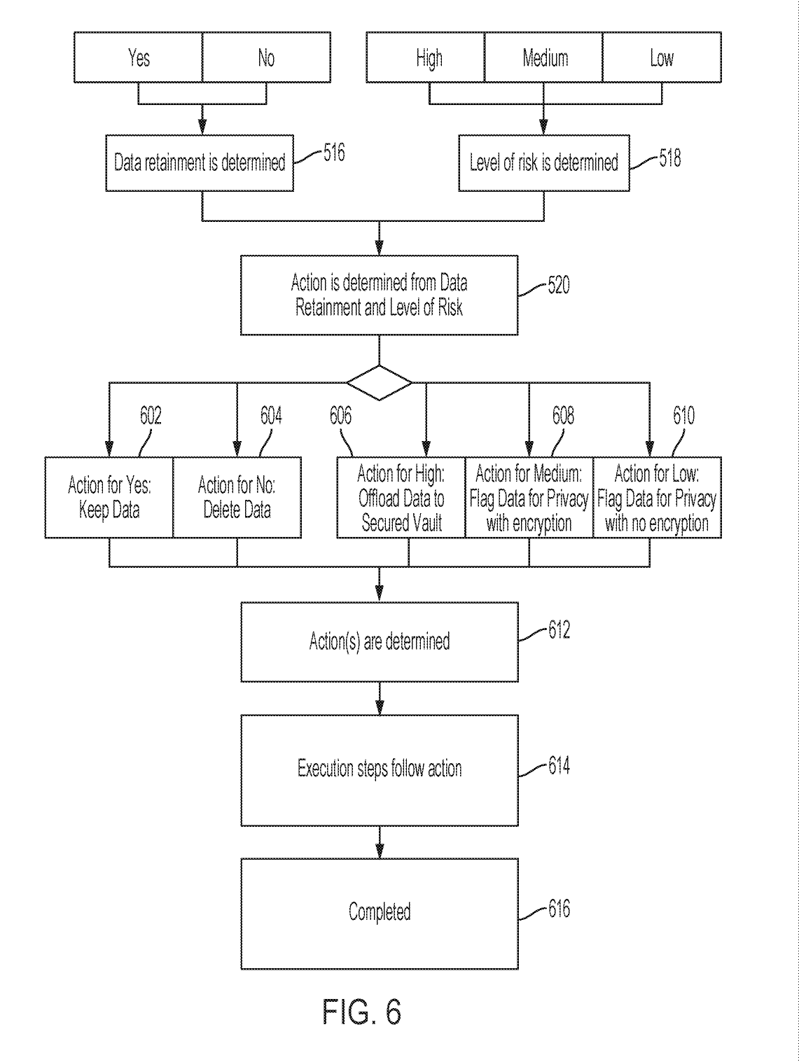

FIG. 6 continues from 5, and illustrates a third flow chart example of the security analysis. In this portion of the flowchart, the respective answers to the data retention determination 516 and the level of risk determination 518 are used to determine the action required 520. Specifically, based on the data retention determination 516, the system may select to keep the data 602 or delete the data 604. Similarly, based on the level of risk of the data 518, the system may select to offload the data to a secured vault 606 (for high risk data), encrypt the data 608 (for medium risk data), or flag the data for privacy with no encryption 610 (for low risk data). Upon making the determinations regarding action to be taken 612, the system can execute steps to follow the action 614. At this point the data is classified and secured, and the security analysis and associated actions are complete 616.

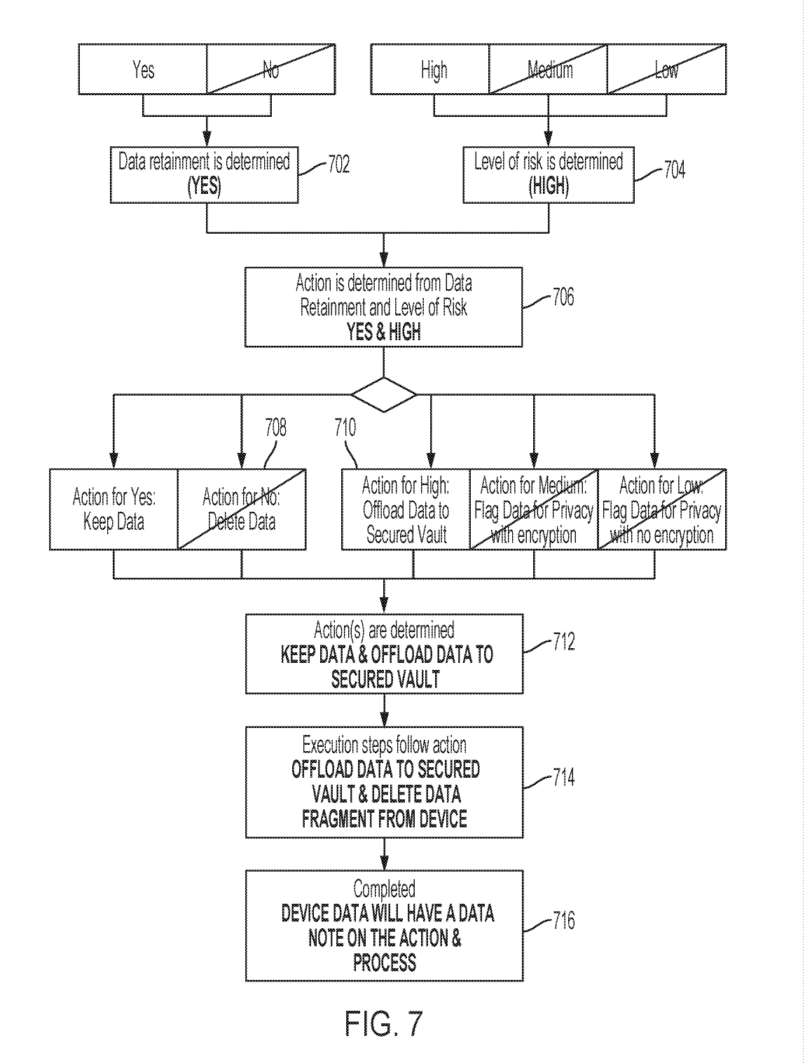

FIG. 7 illustrates an example of the security analysis illustrated in FIG. 6 being performed on flagged data. The data retention determination identifies the data as being retained (YES) 702, and that the level of risk of the data is high 704. Action is then determined from the data retention and the level of risk 706, with this example requiring that the data be kept 708 and offloaded to a secured vault 710, 712. The system then executes those actions by offloading data to a secured vault and deleting the corresponding data fragment from the device 714. At this point, the device data can have a data note on the action and the process performed 716.

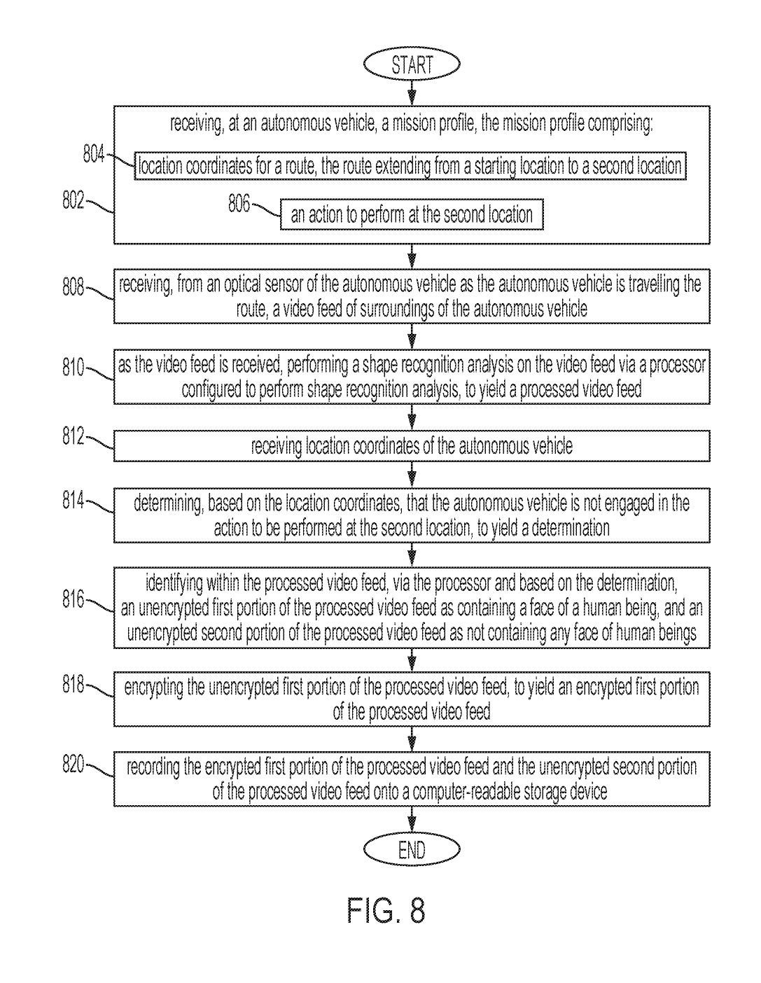

FIG. 8 illustrates an exemplary method embodiment. The steps outlined herein are exemplary and can be implemented in any combination thereof, including combinations that exclude, add, or modify certain steps.

A system configured according to this disclosure can receive, at an autonomous vehicle, a mission profile (802), the mission profile comprising: location coordinates for a route, the route extending from a starting location to a second location (804); and an action to perform at the second location (806). The system can receive, from an optical sensor of the autonomous vehicle as the autonomous vehicle is travelling the route, a video feed of surroundings of the autonomous vehicle (808). As the video feed is received, the system can perform a shape recognition analysis on the video feed via a processor configured to perform shape recognition analysis, to yield a processed video feed (810).

The system can also receive location coordinates of the autonomous vehicle (812) and determine, based on the location coordinates, that the autonomous vehicle is not engaged in the action to be performed at the second location, to yield a determination (814), and identify within the processed video feed, via the processor and based on the determination, an unencrypted first portion of the processed video feed as containing a face of a human being, and an unencrypted second portion of the processed video feed as not containing any face of human beings (816). The system can then encrypt the unencrypted first portion of the processed video feed, to yield an encrypted first portion of the processed video feed (818) and record the encrypted first portion of the processed video feed and the unencrypted second portion of the processed video feed onto a computer-readable storage device (820).

In some configurations, the method can be further expanded to include recording the location coordinates and navigation data for the autonomous vehicle at the autonomous vehicle travels the route. In such configurations, the location coordinates can include Global Positioning System (GPS) coordinates, and the navigation data can include a direction of travel, an altitude, a speed, a direction of optics, and/or other navigation information.

Another way in which the method can be further augmented can be adding the ability for the system to modify a resolution of optics on the autonomous vehicle based on the location coordinates, such that a low resolution of the optics is used by the autonomous vehicle when travelling to the second location, and a higher resolution of the optics is used by the autonomous vehicle when performing the action. For example, the system can use a low resolution when in transit, such that landmarks and other features can be used to navigate, but insufficient to make out features of individual people who may be captured by the optical sensors. Then, as the autonomous vehicle approaches the second location and performs the action, the resolution of the optics can be modified to a higher resolution. This can allow features of a person to be captured as they sign for a product, or as the autonomous vehicle.

Yet another way in which the method can be modified or augmented can include blurring the face within the unencrypted first portion of the processed video feed prior to the encrypting.

In some configurations, the encrypting of the unencrypted first portion can require additional computing power of the processor compared to the computing power required for processing the unencrypted second portion.

In some configurations, the optics on the autonomous vehicle can be directed to a horizon during transit between the starting location and the second location, then changed to a different perspective as the autonomous vehicle approaches the second location and performs the actions required at the second location.

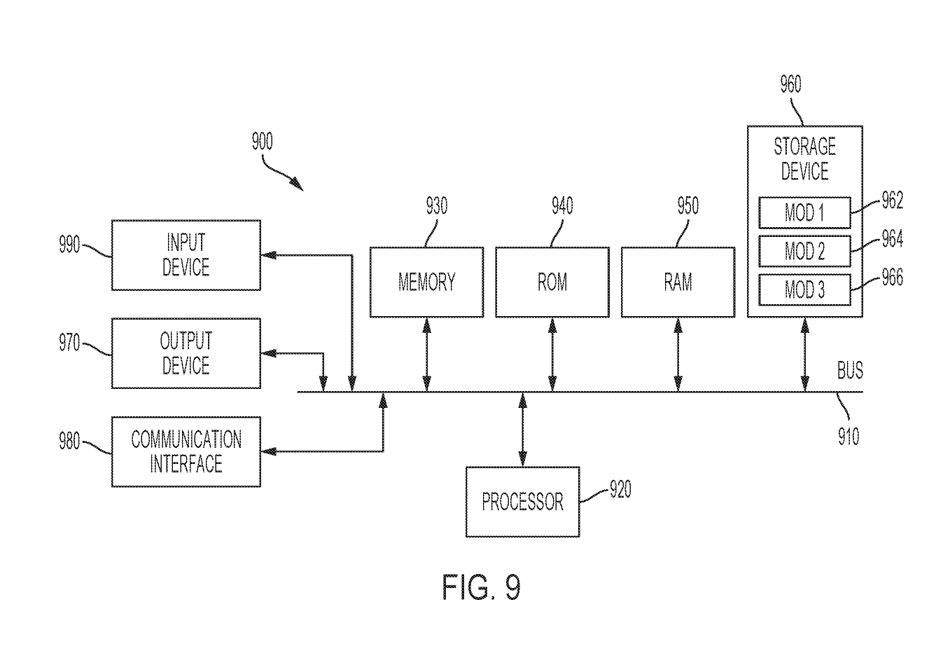

With reference to FIG. 9, an exemplary system includes a general-purpose computing device 900, including a processing unit (CPU or processor) 920 and a system bus 910 that couples various system components including the system memory 930 such as read-only memory (ROM) 940 and random access memory (RAM) 950 to the processor 920. The system 900 can include a cache of high-speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, bus 910, display 970, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 900 is a small, handheld computing device, a desktop computer, or a computer server.

Although the exemplary embodiment described herein employs the hard disk 960, other types of computer-readable media which can store data that are accessible by a computer, such as magnetic cassettes, flash memory cards, digital versatile disks, cartridges, random access memories (RAMs) 950, and read-only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at an autonomous vehicle, a mission profile, the mission profile comprising:
location coordinates for a route, the route extending from a starting location to a second location; and
an action to perform at the second location;
receiving, from an optical sensor of the autonomous vehicle as the autonomous vehicle is travelling the route, a video feed of surroundings of the autonomous vehicle;
as the video feed is received, performing a shape recognition analysis on the video feed via a processor configured to perform shape recognition analysis, to yield a processed video feed;
receiving location coordinates of the autonomous vehicle;
determining, based on the location coordinates, that the autonomous vehicle is not engaged in the action to be performed at the second location, to yield a determination;
identifying within the processed video feed, via the processor and based on the determination, an unencrypted first portion of the processed video feed as containing a face of a human being, and an unencrypted second portion of the processed video feed as not containing any face of human beings;
encrypting the unencrypted first portion of the processed video feed, to yield an encrypted first portion of the processed video feed; and
recording the encrypted first portion of the processed video feed and the unencrypted second portion of the processed video feed onto a computer-readable storage device.

2. The method of claim 1, further comprising:
recording the location coordinates and navigation data for the autonomous vehicle at the autonomous vehicle travels the route.

3. The method of claim 2, wherein the location coordinates comprise Global Positioning System coordinates; and
wherein the navigation data comprises a direction of travel, an altitude, a speed, and a direction of optics.

4. The method of claim 1, further comprising:
modifying, via the processor, a resolution of optics on the autonomous vehicle based on the location coordinates, such that a low resolution of the optics is used by the autonomous vehicle when travelling to the second location, and a higher resolution of the optics is used by the autonomous vehicle when performing the action.

5. The method of claim 1, further comprising:
blurring the face within the unencrypted first portion of the processed video feed prior to the encrypting.

6. The method of claim 1, wherein the encrypting of the unencrypted first portion requires additional computing power of the processor.

7. The method of claim 1, wherein optics on the autonomous vehicle are directed to a horizon during transit between the starting location and the second location.

8. An autonomous vehicle, comprising:
an optical sensor a processor; and
a computer-readable storage medium having instructions stored which, when executed by the processor, cause the processor to perform operation comprising:
receiving a mission profile, the mission profile comprising:
location coordinates for a route, the route extending from a starting location to a second location; and
an action to perform at the second location;
receiving, as the autonomous vehicle is travelling the route, a video feed of surroundings of the autonomous vehicle;
as the video feed is received, performing a shape recognition analysis on the video feed, to yield a processed video feed;
receiving location coordinates of the autonomous vehicle;
determining, based on the location coordinates, that the autonomous vehicle is not engaged in the action to be performed at the second location, to yield a determination;
identifying within the processed video feed, based on the determination, an unencrypted first portion of the processed video feed as containing a face of a human being, and an unencrypted second portion of the processed video feed as not containing any face of human beings;
encrypting the unencrypted first portion of the processed video feed, to yield an encrypted first portion of the processed video feed; and
recording the encrypted first portion of the processed video feed and the unencrypted second portion of the processed video feed onto the computer-readable storage medium.

9. The autonomous vehicle of claim 8, the computer-readable storage medium having additional instructions stored which, when executed by the processor, cause the processor to perform operations comprising:
recording the location coordinates and navigation data for the autonomous vehicle at the autonomous vehicle travels the route.

10. The autonomous vehicle of claim 9, wherein the location coordinates comprise Global Positioning System coordinates; and
wherein the navigation data comprises a direction of travel, an altitude, a speed, and a direction of optics.

11. The autonomous vehicle of claim 8, the computer-readable storage medium having additional instructions stored which, when executed by the processor, cause the processor to perform operations comprising:
modifying a resolution of optics on the autonomous vehicle based on the location coordinates, such that a low resolution of the optics is used by the autonomous vehicle when travelling to the second location, and a higher resolution of the optics is used by the autonomous vehicle when performing the action.

12. The autonomous vehicle of claim 8, the computer-readable storage medium having additional instructions stored which, when executed by the processor, cause the processor to perform operations comprising:
blurring the face within the unencrypted first portion of the processed video feed prior to the encrypting.

13. The autonomous vehicle of claim 8, wherein the encrypting of the unencrypted first portion requires additional computing power of the processor.

14. The autonomous vehicle of claim 8, wherein optics on the autonomous vehicle are directed to a horizon during transit between the starting location and the second location.

15. A non-transitory computer-readable storage device having instructions stored which, when executed by a computing device, cause the computing device to perform operations comprising:
receiving a mission profile to be accomplished by an autonomous vehicle, the mission profile comprising:
location coordinates for a route, the route extending from a starting location to a second location; and
an action to perform at the second location;
receiving, as the autonomous vehicle is travelling the route, a video feed of surroundings of the autonomous vehicle;
as the video feed is received, performing a shape recognition analysis on the video feed, to yield a processed video feed;
receiving location coordinates of the autonomous vehicle;
determining, based on the location coordinates, that the autonomous vehicle is not engaged in the action to be performed at the second location, to yield a determination;
identifying within the processed video feed, based on the determination, an unencrypted first portion of the processed video feed as containing a face of a human being, and an unencrypted second portion of the processed video feed as not containing any face of human beings;
encrypting the unencrypted first portion of the processed video feed, to yield an encrypted first portion of the processed video feed; and
recording the encrypted first portion of the processed video feed and the unencrypted second portion of the processed video feed onto the computer-readable storage device.

16. The computer-readable storage device of claim 15, having additional instructions stored which, when executed by the computing device, cause the computing device to perform operations comprising:
recording the location coordinates and navigation data for the autonomous vehicle at the autonomous vehicle travels the route.

17. The computer-readable storage device of claim 16, wherein the location coordinates comprise Global Positioning System coordinates; and
wherein the navigation data comprises a direction of travel, an altitude, a speed, and a direction of optics.

18. The computer-readable storage device of claim 15, having additional instructions stored which, when executed by the computing device, cause the computing device to perform operations comprising:
modifying a resolution of optics on the autonomous vehicle based on the location coordinates, such that a low resolution of the optics is used by the autonomous vehicle when travelling to the second location, and a higher resolution of the optics is used by the autonomous vehicle when performing the action.

19. The computer-readable storage device of claim 15, having additional instructions stored which, when executed by the computing device, cause the computing device to perform operations comprising:
blurring the face within the unencrypted first portion of the processed video feed prior to the encrypting.

20. The computer-readable storage device of claim 15, wherein the encrypting of the unencrypted first portion requires additional computing power of the computing device.
